(19) United States
(12) Patent Application Publication
(10) Pub. No.: US 2026/0051921 A1
(43) Pub. Date: Feb. 19, 2026

(54) HIGH FREQUENCY MODULE, COMMUNICATION APPARATUS, AND CONTROL METHOD

(71) Applicant: Murata Manufacturing Co., Ltd., Nagaokakyo-shi (JP)

(72) Inventors: Kenji TAHARA, Nagaokakyo-shi (JP); Kae YAMAMOTO, Nagaokakyo-shi (JP)

(21) Appl. No.: 19/369,680

(22) Filed: Oct. 27, 2025

Related U.S. Application Data
(63) Continuation of application No. PCT/JP2024/008067, filed on Mar. 4, 2024.

(30) Foreign Application Priority Data
Apr. 28, 2023 (JP) 2023-074567

(51) Int. Cl. H04B 1/44; H04B 1/401

(52) U.S. Cl. CPC H04B 1/44; H04B 1/401

(57) ABSTRACT

An input terminal, an output terminal, and an antenna terminal; a first transmission line transformer that includes a first transmission line, a second transmission line, and a third transmission line; a first capacitor and a first switch that are connected in series between the input terminal and the output terminal; and a second switch that is connected between the output terminal and a ground terminal, are provided. The first transmission line includes a first end portion that is connected to the input terminal and a second end portion. The second transmission line includes a third end portion that is connected to the output terminal and a fourth end portion that is connected to the input terminal. The third transmission line includes a fifth end portion that is connected to the second end portion and a sixth end portion that is connected to the antenna terminal.

### CROSS REFERENCE TO RELATED APPLICATION

This is a continuation of International Application No. PCT/JP2024/008067 filed on Mar. 4, 2024 which claims priority from Japanese Patent Application No. 2023-074567 filed on Apr. 28, 2023. The contents of these applications are incorporated herein by reference in their entireties.

### BACKGROUND OF THE DISCLOSURE

### Field of the Disclosure

The present disclosure generally relates to a high frequency module, a communication apparatus including the high frequency module, and a control method, and more particularly, to a technique for improving isolation between transmission and reception circuits while reducing the size of the high frequency module.

### Description of the Related Art

As electronic apparatuses capable of transmitting and receiving radio waves of radio frequency (RF), electronic apparatuses including an antenna for transmission and an antenna for reception separately and electronic apparatuses including an antenna used for both transmission and reception have been known.

In U.S. Pat. No. 10,715,204, an electronic apparatus including an antenna used for both transmission and reception is disclosed. The antenna used for both transmission and reception in U.S. Pat. No. 10,715,204 includes a power amplifier for transmission and a low noise amplifier for reception, and switching between a transmission circuit and a reception circuit is performed using a switch.

### BRIEF SUMMARY OF THE DISCLOSURE

In the case of a magnetic field coupling transformer for transmission and a magnetic field coupling transformer for reception described in U.S. Pat. No. 10,715,204, a switch including a semiconductor is typically used as a switch for switching of coupling between transmission and reception. In this case, a parasitic capacitance, which is inevitably generated in the switch, causes part of the high frequency to pass through the switch, and this may degrade the characteristics of the isolation between the transmission circuit and the reception circuit. When a transmission signal of large electric power is transmitted, if the transmission signal of large electric power flows into the reception circuit due to the degradation of isolation, the reception circuit may be damaged. Furthermore, in recent years, there has been a trend of decrease in the size of electronic apparatuses, and it has also been desirable to suppress an increase in the size of electronic apparatuses including an antenna.

The present disclosure has been designed to solve the problems mentioned above, and a possible benefit of the present disclosure is to improve the characteristics of the isolation between transmission and reception circuits while reducing the size of a high frequency module that performs transmission and reception of a high frequency signal using an antenna.

A high frequency module according to the present disclosure includes an input terminal, an output terminal, and an antenna terminal; a first transmission line transformer that includes a first transmission line, a second transmission line, and a third transmission line; a first capacitor and a first switch that are connected in series between the input terminal and the output terminal; and a second switch that is connected between the output terminal and a ground terminal. The first transmission line includes a first end portion that is connected to the input terminal and a second end portion. The second transmission line includes a third end portion that is connected to the output terminal and a fourth end portion that is connected to the input terminal. The third transmission line includes a fifth end portion that is connected to the second end portion and a sixth end portion that is connected to the antenna terminal. The first capacitor and the first switch are connected in series between the first end portion and the third end portion.

According to the present disclosure, in a high frequency module that performs switching between transmission and reception circuits by using a switch, a transmission line transformer and a capacitor form a parallel resonance circuit at the time of transmission. Thus, resonance in the parallel resonance circuit prevents transmission of a transmission frequency band to the reception circuit. Furthermore, at the time of reception, the transmission line transformer functions as an inductor for impedance matching. That is, since the transmission line transformer can be shared between a circuit for transmission and a circuit for reception, there is no need to provide an inductor for impedance matching separately. Thus, the characteristics of the isolation between the transmission and reception circuits can be improved while the size of the high frequency module is reduced.

### BRIEF DESCRIPTION OF THE SEVERAL VIEWS OF THE DRAWINGS

FIG. 1 is a schematic configuration diagram of a communication apparatus according to a first embodiment.

FIG. 2 is a circuit diagram illustrating a detailed configuration of a high frequency module according to the first embodiment.

FIG. 3 is a schematic diagram of transmission lines in the first embodiment.

FIG. 4 is a diagram for explaining transmission paths for a high frequency signal at the time of reception in the first embodiment.

FIG. 5 is a diagram for explaining transmission paths for a high frequency signal at the time of transmission in the first embodiment.

FIG. 6 is a schematic diagram for explaining an LC parallel resonance circuit including a capacitor and a transmission line.

FIG. 7 is a diagram illustrating insertion loss of the LC parallel resonance circuit.

FIG. 8 is a diagram for explaining an operation of a TLT circuit in the first embodiment.

FIG. 9 is a diagram illustrating a detailed configuration of a high frequency module according to a comparative example.

FIG. 10 is a diagram illustrating a flowchart of a process performed in a signal processing circuit.

FIG. 11 is a schematic diagram of transmission lines in a second embodiment.

FIG. 12 is a diagram illustrating a detailed configuration of a high frequency module according to a first modification.

FIG. 13 is a diagram illustrating a detailed configuration of a high frequency module according to a second modification.

FIG. 14 is a diagram for explaining an operation of a Doherty amplifier.

FIG. 15 is a diagram illustrating a detailed configuration of a high frequency module according to a third modification.

FIG. 16 is a diagram illustrating a detailed configuration of a high frequency module according to a fourth modification.

FIG. 17 is a diagram illustrating a detailed configuration of a high frequency module according to a fifth modification.

FIG. 18 is a schematic configuration diagram of a communication apparatus according to a sixth modification.

FIG. 19 is a diagram illustrating a detailed configuration of a high frequency module according to the sixth modification.

### DETAILED DESCRIPTION OF THE DISCLOSURE

Hereinafter, embodiments of the present disclosure will be described in detail with reference to the drawings. The same signs are assigned to the same or corresponding parts in the drawings, and repetitive description of those same or corresponding parts will not be provided.

### First Embodiment

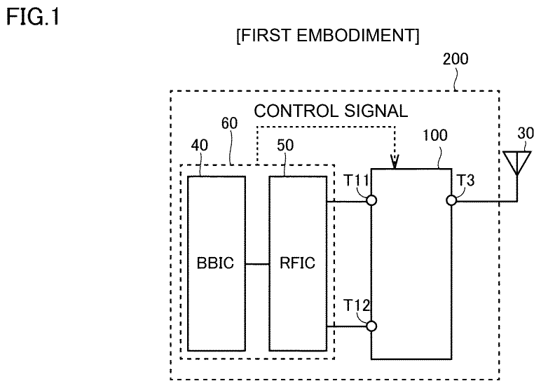

A schematic configuration of a high frequency module 100 and a communication apparatus 200 according to a first embodiment will be described with reference to FIG. 1. FIG. 1 is a schematic configuration diagram of the communication apparatus 200 according to the first embodiment.

A circuit configuration of the communication apparatus 200 will be described below. The communication apparatus 200 is an apparatus used in a communication system and is, for example, a mobile terminal such as a smartphone or a tablet, or a personal computer including a communication function. As illustrated in FIG. 1, the communication apparatus 200 according to the first embodiment includes the high frequency module 100 and a signal processing circuit 60. The high frequency module 100 is connected to an antenna 30 for transmitting and receiving radio waves. The signal processing circuit 60 includes a baseband integrated circuit (BBIC) 40 including a baseband signal processing circuit and a radio frequency integrated circuit (RFIC) 50.

The high frequency module 100 transfers a high frequency signal between the antenna 30 and the RFIC 50. The antenna 30 receives, through a connection terminal T11 of the high frequency module 100, a high frequency (radio frequency: RF) signal outputted from the RFIC 50, and transmits the high frequency signal as a radio wave. Furthermore, a high frequency signal (reception signal) received at the antenna 30 is transmitted, through a connection terminal T3 and then the high frequency module 100, to the RFIC 50.

The RFIC 50 processes high frequency signals transmitted and received to and from the antenna 30. Specifically, the RFIC 50 receives, through a connection terminal T12, a reception signal of an RF signal received at the antenna 30. The RFIC 50 converts, by down-conversion, the reception signal into an intermediate frequency (IF) signal, and outputs the generated IF signal to the BBIC 40. Furthermore, the RFIC 50 converts, by up-conversion, a transmission signal of an IF signal received from the BBIC 40 into an RF signal, and outputs, through the connection terminal T11, the generated RF signal to the high frequency module 100.

In the example of the first embodiment, a transmission frequency band is 60 GHZ. The transmission frequency band is not necessarily 60 GHZ and may be other frequency bands, for example, 28 GHZ, 39 GHZ, or the like. In the communication apparatus 200 according to the first embodiment, filtering processing is performed on a transmission signal. For example, in the communication apparatus 200, a radio wave in a transmission frequency band that is determined in advance by a filter device and/or a band selector switch, which is not illustrated in the drawing, is transmitted from the antenna 30.

The BBIC 40 or the RFIC 50 of the signal processing circuit 60 includes a controller, which is not illustrated in the drawing, and a switch, an amplifier, and the like described later included in the high frequency module 100 are controlled in accordance with a control signal from the signal processing circuit 60. Part of or the entire function as the controller may be implemented outside the signal processing circuit 60.

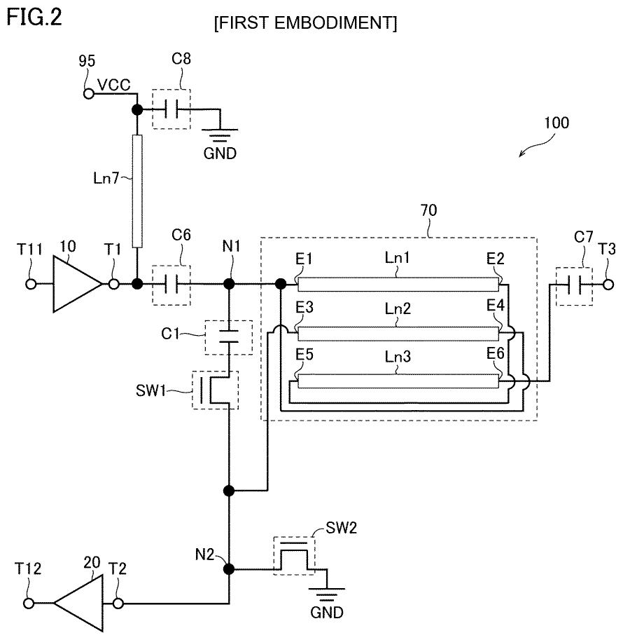

FIG. 2 is a circuit diagram illustrating a detailed configuration of the high frequency module 100 according to the first embodiment. Referring to FIG. 2, the high frequency module 100 includes connection terminals T11, T12, T1, T2, and T3, a power amplifier 10, a low noise amplifier 20, and a transmission line transformer (TLT) circuit 70.

The TLT circuit 70 includes transmission lines Ln1, Ln2, and Ln3 that are magnetically coupled to each other. The transmission line Ln1 includes end portions E1 and E2. The transmission line Ln2 includes end portions E3 and E4. The transmission line Ln3 includes end portions E5 and E6. One end of a capacitor C6 is connected to the end portion E1 of the transmission line Ln1. The other end of the capacitor C6 is connected to the connection terminal T11 with the connection terminal T1 and the power amplifier 10 interposed therebetween. The power amplifier 10 is connected between the connection terminal T1 and the connection terminal T11. In the example of FIG. 1, the high frequency module 100 includes the power amplifier 10. However, the power amplifier 10 may be arranged outside the high frequency module 100. The end portion E5 of the transmission line Ln3 is connected to the end portion E2 of the transmission line Ln1.

The end portion E3 of the transmission line Ln2 is connected to the connection terminal T12 with the connection terminal T2 and the low noise amplifier 20 interposed therebetween. The low noise amplifier 20 is connected between the connection terminal T2 and the connection terminal T12. In the example of FIG. 1, the high frequency module 100 includes the low noise amplifier 20. However, the low noise amplifier 20 may be arranged outside the high frequency module 100.

Furthermore, a switch SW2 is connected between the end portion E3 and a ground terminal GND. When the switch SW2 is electrically connected, a shunt line is formed. The end portion E1 of the transmission line Ln1 is connected to the end portion E4 of the transmission line Ln2. That is, the end portion E4 is connected to the connection terminal T1.

The end portion E2 of the transmission line Ln1 is connected to the end portion E5 of the transmission line Ln3, as described above. The connection terminal T3 is connected to the end portion E6 of the transmission line Ln3 with a capacitor C7 interposed therebetween. Furthermore, a capacitor C1 and a switch SW1 are connected in series between the end portion E1 of the transmission line Ln1 and the end portion E3 of the transmission line Ln2. That is, the capacitor C1 and the switch SW1, which are connected in series, are connected in parallel to the transmission line Ln2. The order of connection of the capacitor C1 and the switch SW1 that are connected in series may be opposite to that in the example illustrated in FIG. 2. That is, in an aspect, the capacitor C1 may be connected to the switch SW2 and the switch SW1 may be connected to the end portion E1.

A power supply terminal 95 is connected to an output terminal of the power amplifier 10 with a power supply line Ln7 interposed therebetween. The power supply terminal 95 is a terminal to which a power supply voltage VCC, which is to be externally supplied to the power amplifier 10, is inputted. Furthermore, the power supply terminal 95 is connected to a ground terminal GND with a capacitor C8 interposed therebetween. The capacitor C8 functions as a bypass capacitor that suppresses noise in the power supply voltage VCC, which is supplied from the power supply terminal 95 to the power amplifier. The capacitors C6 and C7 function as DC-cutting capacitors for blocking a DC component in a transmission signal outputted from the power amplifier 10. The power supply line Ln7 is a ¼-wavelength transmission line. Thus, a transmission signal outputted from the power amplifier 10 is not transmitted to the power supply terminal 95, but is transmitted to the capacitor C6.

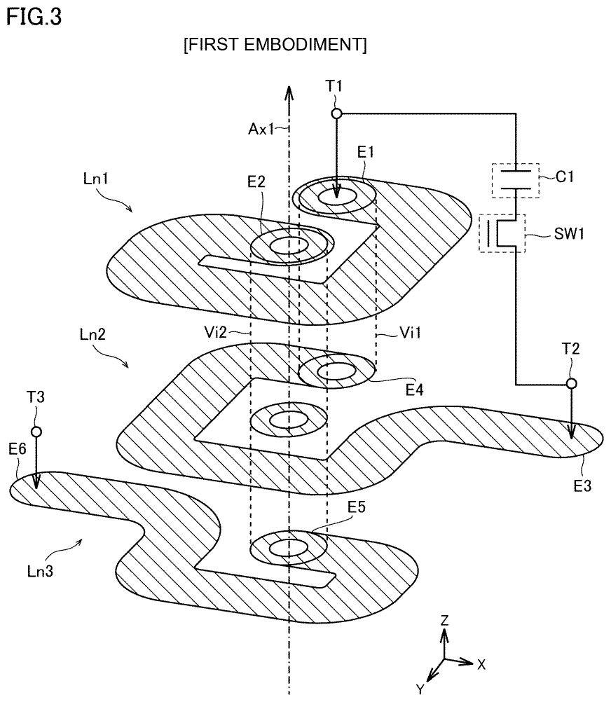

In the first embodiment, each of the switches SW1 and SW2 is electrically connected when a high frequency signal is transmitted from the antenna 30 (transmission mode) and is not electrically connected when a high frequency signal is received at the antenna 30 (reception mode). The shapes of the transmission lines Ln1 to Ln3 illustrated in FIG. 3 will be explained below. After that, signal paths for reception and transmission in the high frequency module will be described.

### <Shapes of Transmission Lines in First Embodiment>

FIG. 3 is a schematic diagram of the transmission lines Ln1 to Ln3 in the first embodiment. As illustrated in FIG. 3, each of the transmission lines Ln1 to Ln3 has a flat-plate shape, and the transmission lines Ln1 to Ln3 are stacked in the order illustrated in FIG. 3 in a multilayer body in which a plurality of dielectric layers are stacked. In FIG. 3, the connection terminals T1 to T3, the capacitor C1, and the switch SW1 are indicated as symbols, in addition to the shapes of the transmission lines Ln1 to Ln3. In FIG. 3, illustration of component elements using symbols, such as the power amplifier 10, the low noise amplifier 20, the capacitors C6 and C7, the switch SW2, and the power supply terminal 95, which have been described above with reference to FIG. 2, is omitted.

In the description provided below, a stacking direction in which the transmission lines Ln1 to Ln3 are stacked will be referred to as a “Z-axis direction,” a direction perpendicular to the Z-axis will be referred to as an “X-axis direction,” and a direction perpendicular to both the Z-axis and the X-axis will be referred to as a “Y-axis direction.” A Z-axis positive direction may be referred to as an upper side, and a Z-axis negative direction may be referred to as a lower side.

Each of the transmission lines Ln1 to Ln3 has, when seen in a plan view from the Z-axis positive direction, a coil shape winding around an axis Ax1 indicated by a one-dot chain line. The end portion E1 of the transmission line Ln1 and the end portion E4 of the transmission line Ln2 are connected by a via Vi1 extending in the stacking direction. That is, the end portion E1 and the end portion E4 are arranged at positions that overlap when seen in a plan view from the Z-axis direction. The end portion E2 of the transmission line Ln1 and the end portion E5 of the transmission line Ln3 are connected by a via Vi2 extending in the stacking direction. That is, the end portion E2 and the end portion E5 are arranged at positions that overlap when seen in a plan view from the Z-axis direction.

### <Reception Mode>

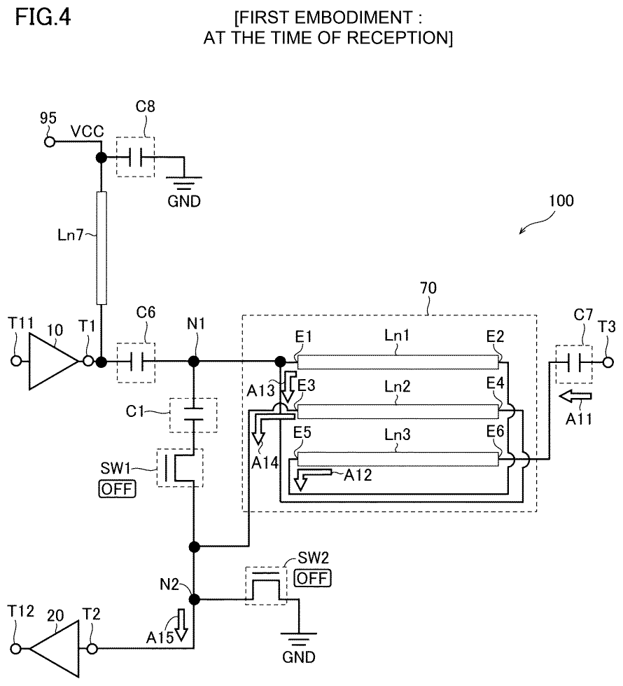

FIG. 4 is a diagram for explaining transmission paths for a high frequency signal in the reception mode in the first embodiment. At the time of reception at the antenna 30, the signal processing circuit 60 illustrated in FIG. 1 controls each of the switches SW1 and SW2 to be electrically disconnected, as illustrated in FIG. 4. In the reception mode, by controlling bias signals for the power amplifier 10 and the low noise amplifier 20, the signal processing circuit 60 controls the power amplifier 10 to be turned off (non-operating state) and controls the low noise amplifier 20 to be turned on (operating state).

A reception signal received at the antenna 30 is transmitted through the connection terminal T3 and then the capacitor C7 to the transmission line Ln3, as indicated by an arrow A11. After that, the reception signal is transmitted from the transmission line Ln3 to the transmission line Ln1, as indicated by an arrow A12. In the reception mode, since the power amplifier 10 is controlled to be in the off state, the output terminal of the power amplifier 10 is in an open state. That is, the TLT circuit 70 and the power amplifier 10 are not electrically connected. Furthermore, in the reception mode, the switch SW1 is not electrically connected. Therefore, the reception signal that has passed through the transmission line Ln1 is transmitted from the transmission line Ln1 to the transmission line Ln2, as indicated by an arrow A13.

In the reception mode, since the switches SW1 and SW2 are each electrically disconnected, the reception signal that has passed through the transmission line Ln2 is amplified with low noise by the low noise amplifier 20 and outputted to the connection terminal T12, as indicated by arrows A14 and A15. As described above, in the first embodiment, the reception signal received at the antenna 30 is transmitted through the transmission paths indicated by the arrows A11 to A15 illustrated in FIG. 4 to the connection terminal T12.

Referring to FIG. 3, in the reception mode, the reception signal received from the connection terminal T3 is transmitted from the end portion E6 to the end portion E5 of the transmission line Ln3. The transmission path from the end portion E6 to the end portion E5 is wound approximately one turn in a counterclockwise manner when seen in a plan view from the Z-axis positive direction. The number of turns of the transmission line Ln3 is approximately one.

Then, the reception signal that has passed through the end portion E5 of the transmission line Ln3 is transmitted through the via Vi2 to the end portion E2 of the transmission line Ln1. After that, the reception signal is transmitted from the end portion E2 to the end portion E1 of the transmission line Ln1. The transmission path from the end portion E2 to the end portion E1 is also wound approximately one turn in a counterclockwise manner when seen in a plan view from the Z-axis positive direction. The number of turns of the transmission line Ln1 is approximately one.

Then, the reception signal that has passed through the end portion E2 of the transmission line Ln1 is transmitted through the via Vi1 to the end portion E4 of the transmission line Ln2. After that, the reception signal is transmitted from the end portion E4 to the end portion E3 of the transmission line Ln2. The transmission path from the end portion E4 to the end portion E3 is also wound approximately one turn in a counterclockwise manner when seen in a plan view from the Z-axis positive direction. The number of turns of the transmission line Ln2 is approximately one. Finally, the reception signal is transmitted from the end portion E3 to the connection terminal T2. In the example of the first embodiment, the number of turns of each of the transmission lines Ln1 to Ln3 is approximately one.

As described above, since the transmission lines Ln1 to Ln3 have the shapes illustrated in FIG. 3, in the reception mode, when the reception signal passes through each of the transmission lines Ln1 to Ln3, the reception signal goes winding approximately one turn in a counterclockwise direction. Thus, the transmission lines Ln1 to Ln3 function as a coil in an integrated manner, as indicated by the arrows A12, A13, and A14, which have been described above with reference to FIG. 4. The coil including the transmission lines Ln1, Ln2, and Ln3 functions as a matching circuit for matching the impedance between the low noise amplifier 20 and the connection terminal T3. Thus, in the first embodiment, a reception signal received at the antenna 30 is transmitted to the low noise amplifier 20 while loss in the reception signal caused by impedance mismatch is suppressed.

### <Transmission Mode>

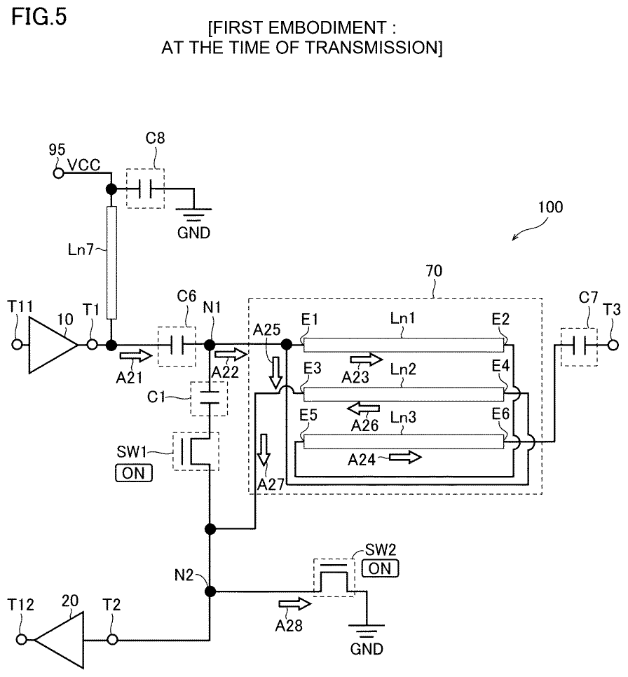

FIG. 5 is a diagram for explaining transmission paths for a high frequency signal in the transmission mode in the first embodiment. The signal processing circuit 60 in FIG. 1 controls each of the switches SW1 and SW2 to be electrically connected as illustrated in FIG. 5, and controls the high frequency module 100 to be able to output to the antenna 30 a transmission signal inputted from the RFIC 50. In the transmission mode, the signal processing circuit 60 controls the power amplifier 10 to be turned on and controls the low noise amplifier 20 to be turned off.

Specifically, a transmission signal that has been up-converted by the RFIC 50 is inputted through the connection terminal T11 to the power amplifier 10. The power amplifier 10 amplifies the received transmission signal and outputs the amplified transmission signal through the input terminal. The signal processing circuit 60 controls the power amplifier 10 to be turned on.

The transmission signal that has been amplified by the power amplifier 10 is transmitted to the capacitor C6, as indicated by an arrow A21. The transmission signal that has passed through the capacitor C6 is transmitted to the end portion E1 of the transmission line Ln1, as indicated by arrows A22 and A23, and is also transmitted to the end portion E4 of the transmission line Ln2, as indicated by arrows A22 and A25.

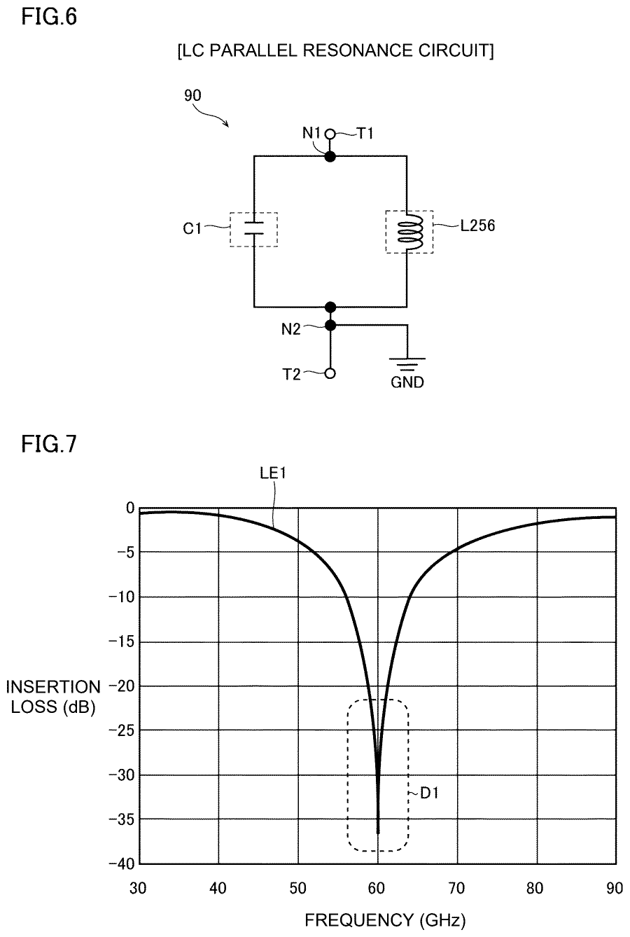

In the high frequency module 100 according to the first embodiment, by causing each of the switches SW1 and SW2 to be electrically connected, the capacitor C1 and the transmission line Ln2 form an LC parallel resonance circuit 90 that is grounded at a connection node N2, as illustrated in FIG. 6. FIG. 6 is a schematic diagram for explaining the LC parallel resonance circuit 90. In FIG. 6, a configuration that is not necessary for explanation of the LC parallel resonance circuit 90 is omitted.

More specifically, the transmission line Ln2 functions as an inductor L256. As illustrated in FIG. 6, the inductor L256 is connected in parallel with the capacitor C1. Thus, the capacitor C1 and the transmission line Ln2, which functions as the inductor L256, form the LC parallel resonance circuit 90.

FIG. 7 is a diagram indicating insertion loss of the LC parallel resonance circuit 90. In FIG. 7, a line LE1 representing the insertion loss of the LC parallel resonance circuit 90 is indicated. As illustrated in FIG. 7, in the LC parallel resonance circuit 90, the inductance of the inductor L256 and the capacitance of the capacitor C1 are set in such a manner that an attenuation pole D1 is generated near 60 GHz.

For example, the inductance of the inductor L256 is 0.02 nH, and the capacitance of the capacitor C1 is 0.25 pF. Therefore, due to the LC parallel resonance circuit 90, the transmission signal that has passed through the capacitor C6 illustrated in FIG. 5 is not transmitted to the input terminal of the low noise amplifier 20. That is, due to the LC parallel resonance circuit 90, the isolation between the power amplifier 10 and the low noise amplifier 20 is secured.

In the case where the isolation between the power amplifier 10 and the low noise amplifier 20 is secured by causing a switch disposed on a signal transmission path between the power amplifier 10 and the low noise amplifier 20 to be electrically disconnected, the isolation between the transmission and reception circuits may be degraded due to the parasitic capacitance of the switch. In the first embodiment, with the resonance in the LC parallel resonance circuit 90, the isolation between the power amplifier 10 and the low noise amplifier 20 in the transmission frequency band is secured. That is, in the first embodiment, with the LC parallel resonance circuit 90, which is configured when the switch SW1 is electrically connected, characteristics of the isolation between the power amplifier 10 and the low noise amplifier 20 in the transmission mode can be improved.

Transmission paths for a transmission signal transmitted in the transmission mode will be described below with reference to FIG. 3. In the transmission mode, a transmission signal is transmitted from the connection terminal T1 to the end portion E1 of the transmission line Ln1. The end portion E1 is connected to the end portion E2. The end portion E1 is also connected to the end portion E4 by the via Vi1. A transmission path from the end portion E4 to the end portion E3 is wound approximately one turn in a clockwise manner when seen in a plan view from the Z-axis positive direction. Thus, the transmission path from the end portion E4 to the end portion E3 forms the inductor L256 described above with reference to FIG. 6.

As illustrated in FIG. 3, the transmission line Ln2, which forms the inductor L256, and the capacitor C1 are connected in parallel between the connection terminals T1 and T2. As described above with reference to FIG. 6, the capacitor C1 and the inductor L256 form the LC parallel resonance circuit 90, which prevents transmission of a transmission signal to the low noise amplifier 20. That is, in the first embodiment, the characteristics of the isolation between the low noise amplifier 20 and the power amplifier 10 can be improved in the transmission mode.

In the transmission mode, the transmission signal inputted from the connection terminal T11 is transmitted from the end portion E1 to the end portion E2 of the transmission line Ln1. After that, the transmission signal is transmitted through the via Vi2 to the end portion E5 of the transmission line Ln3. The transmission signal is transmitted from the end portion E5 to end portion E6 of the transmission line Ln3. Finally, the transmission signal is transmitted from the end portion E6 of the transmission line Ln3 through the connection terminal T3 to the antenna 30 and is transmitted as a radio wave.

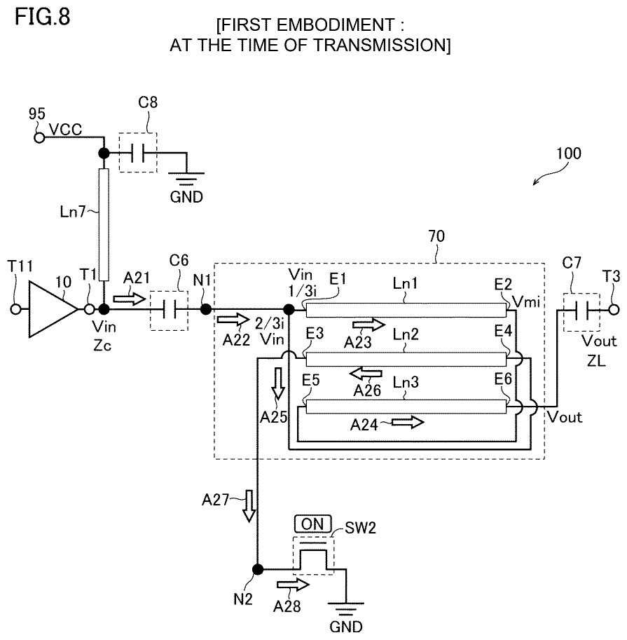

FIG. 8 is a diagram for explaining an operation of the TLT circuit 70 in the first embodiment. With reference to FIG. 8, transmission paths indicated by the arrows A22 and A23 for a transmission signal will be described.

A transmission signal that has been amplified by the power amplifier 10 is transmitted from the end portion E1 to the end portion E2 of the transmission line Ln1, as indicated by the arrows A22 and A23. The transmission signal that has passed through the transmission line Ln1 is transmitted from the end portion E5 to the end portion E6 of the transmission line Ln3, as indicated by the arrow A24. Furthermore, the transmission signal that has passed through the transmission line Ln3 is transmitted through the capacitor C7 to the connection terminal T3 and then transmitted as a radio wave from the antenna 30.

As illustrated in FIG. 8, the transmission signal is transmitted through the transmission line Ln1 and then through the transmission line Ln3. That is, the size of the current of the transmission signal that flows through the transmission line Ln1 is the same as the size of the current of the transmission signal that flows through the transmission line Ln3. Since a reverse current of the transmission signal flowing through the transmission line Ln1 flows in the transmission line Ln2, the currents flowing in the transmission lines Ln1 and Ln2 are in an odd mode and a reverse voltage is excited in the transmission line Ln2. Similarly, since a reverse current of the transmission signal flowing through the transmission line Ln3 flows in the transmission line Ln2, the currents flowing in the transmission lines Ln2 and Ln3 are in the odd mode and a reverse voltage is excited in the transmission line Ln2.

The odd mode current caused by the reverse voltage excited by the transmission line Ln1 and the odd mode current caused by the reverse voltage excited by the transmission line Ln3 are the same in size and direction. That is, in the transmission line Ln2, the reverse voltage by the transmission line Ln1 and the reverse voltage by the transmission line Ln3 are superimposed on each other. Thus, the odd mode current of the size that is twice the size of the current flowing in a series circuit including the transmission line Ln1 and the transmission line Ln3 is excited in the transmission line Ln2.

With the configuration in the first embodiment, a current of a value that is one third the value of a current i flows to the series circuit including the transmission line Ln1 and the transmission line Ln3, as illustrated in FIG. 8, where the size of the transmission signal that has been amplified by the power amplifier 10 is represented by i. Furthermore, a current of a value that is two thirds the value of the current i flows to the transmission line Ln2, as illustrated in FIG. 8. That is, the current of the value that is one third the value of the current i is output to the connection terminal T3.

The voltage of the transmission signal that has been amplified by the power amplifier 10 is represented by Vin, the voltage at the connection terminal T3 is represented by Vout, the voltage at the end portion E2 of the transmission line Ln1 is represented by Vmi. Each of the voltage at the end portion E1 of the transmission line Ln1 and the voltage at the end portion E4 of the transmission line Ln2 is equal to the voltage Vin, which has been amplified by the power amplifier 10. The voltage at the end portion E6 of the transmission line Ln3 is equal to the voltage Vout at the connection terminal T3. Furthermore, the voltage at the end portion E5 of the transmission line Ln3 is equal to the voltage Vmi at the end portion E2 of the transmission line Ln1. The voltage at the end portion E3 of the transmission line Ln2 is connected to the ground terminal GND and is thus 0 V.

The impedance between the transmission lines Ln1 and Ln2 is adjusted in such a manner that the potential difference between the end portion E1 and the end portion E2 of the transmission line Ln1 is equal to the potential difference between the end portion E3 and the end portion E4 of the transmission line Ln2. Thus, the equation Vin-Vmi=0−Vin is satisfied. Similarly, the equation Vmi-Vout=0−Vin is satisfied between the transmission line Ln3 and the transmission line Ln2. That is, the equation 3×Vin=Vout is obtained. As described above, the voltage Vout at the connection terminal T3 is triple the voltage Vin that has been amplified by the power amplifier 10.

When the load of an impedance ZL is connected to the capacitor C7, the equation Vout=(1/3)i×ZL is satisfied. The equation Vin=Zc×i is satisfied, where the impedance when the load side is seen from the power amplifier 10 is represented by Zc. That is, the expression Zc=Vin/i=(Vout/3)/i=Zc/9 is satisfied, and the equation Zc=(1/9) ZL is obtained. As described above, the size of the impedance Zc when the load side is seen from the power amplifier 10 is one ninth the size of the impedance ZL of the load connected to the connection terminal T3. That is, in the first embodiment, the TLT circuit 70 can be made to function as an impedance conversion circuit with an impedance conversion ratio of 9.

### COMPARATIVE EXAMPLES

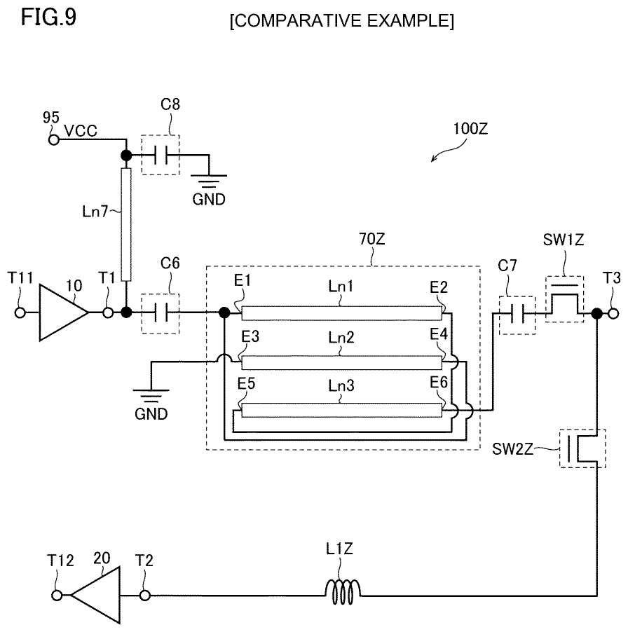

FIG. 9 is a diagram illustrating a detailed configuration of a high frequency module 100Z according to a comparative example. Unlike in the high frequency module 100 according to the first embodiment, an inductor L1Z and a switch SW2Z are connected between the input terminal of the low noise amplifier 20 and the connection terminal T3 in the high frequency module 100Z according to this comparative example. Furthermore, in the high frequency module 100Z according to this comparative example, a switch SW1Z is connected between the capacitor C7 and the connection terminal T3. A TLT circuit 70Z in the high frequency module 100 according to this comparative example functions as an impedance matching circuit because of excitation of the odd mode current explained above with reference to FIG. 8.

In the high frequency module 100Z according to this comparative example, in the transmission mode, the signal processing circuit 60 causes the switch SW1Z to be electrically connected, causes the power amplifier 10 to be turned on, causes the switch SW2Z to be electrically disconnected, and causes the low noise amplifier 20 to be turned off. However, in the high frequency module 100Z according to this comparative example, even when the switch SW2Z is not electrically connected, the isolation between input and output degrades due to the parasitic capacitance of the switch SW2Z.

As described above with reference to FIGS. 5 to 7, in the first embodiment, with the resonance in the LC parallel resonance circuit 90, the isolation between the power amplifier 10 and the low noise amplifier 20 in the transmission frequency band is secured. That is, in the first embodiment, even if the transmission frequency band is high, with the LC parallel resonance circuit 90, which is configured when the switch SW1 is electrically connected, the characteristics of the isolation between the power amplifier 10 and the low noise amplifier 20 in the transmission mode can be improved.

Furthermore, in the high frequency module 100Z according to this comparative example, a region in which the inductor L1Z for the reception side is provided is needed, which increases the size of the high frequency module 100Z. As described above with reference to FIG. 4, in the high frequency module 100 according to the first embodiment, with switching of the switches SW1 and SW2, the transmission lines Ln1 to Ln3 are integrated together to form an inductor, and impedance matching can thus be achieved.

Therefore, in the high frequency module 100 according to the first embodiment, the inductor L1Z does not need to be provided separately, and the TLT circuit 70 can be used as a matching circuit for both transmission and reception. Thus, the size of the high frequency module 100 can be reduced. Furthermore, in the high frequency module 100 according to the first embodiment, the antenna 30 can also be used for both transmission and reception. Thus, the size of the high frequency module 100 can be reduced compared to the case where an antenna for transmission and an antenna for reception are provided separately.

Furthermore, in the high frequency module 100Z according to this comparative example, when the switch SW1Z is electrically connected, a transmission signal passes through the switch SW1Z and is transmitted from the connection terminal T11 to the connection terminal T3. Similarly, in the high frequency module 100Z according to this comparative example, when the switch SW2Z is electrically connected, a reception signal passes through the switch SW2Z and is transmitted from the connection terminal T3 to the connection terminal T2. That is, in this comparative example, since the switches SW1Z and SW2Z are disposed on transmission paths for signals, loss occurs in the switches SW1Z and SW2Z when the signals are transmitted. In contrast, in the first embodiment, since neither the switch SW1 nor the switch SW2 is disposed on a transmission path for a transmission/reception signal, occurrence of loss in the switches SW1 and SW2 when signals are transmitted can be suppressed.

As described above, in the high frequency module 100 according to the first embodiment that performs switching between the transmission and reception circuits by using the switches SW1 and SW2, the transmission line Ln2 and the capacitor C1 form the LC parallel resonance circuit 90 at the time of transmission. Thus, resonance in the LC parallel resonance circuit 90 prevents transmission of a transmission frequency band to the reception circuit. Furthermore, at the time of reception, the TLT circuit 70 functions as a coil for impedance matching. Thus, there is no need to separately provide an inductor for impedance matching. As described above, by functioning as an impedance matching circuit that is different between transmission and reception, the TLT circuit 70 in the first embodiment is used for both transmission and reception.

Accordingly, the characteristics of the isolation between the transmission and reception circuits can be improved while the size of the high frequency module is reduced. Furthermore, since neither the switch SW1 nor the switch SW2 is connected on a transmission path for a transmission/reception signal, occurrence of loss can be suppressed.

### <Process at Signal Processing Circuit 60>

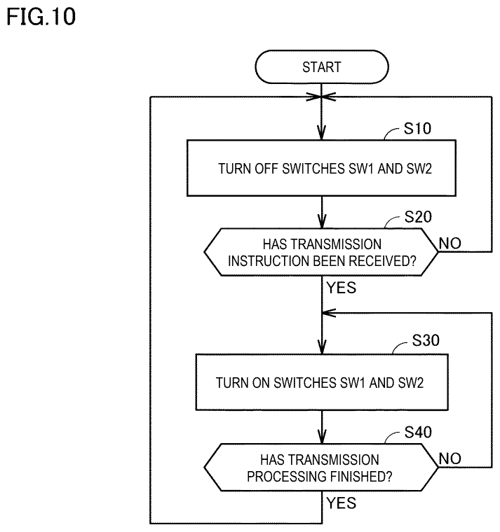

FIG. 10 is a diagram illustrating a flowchart of a process performed at the signal processing circuit 60. The flowchart illustrated in FIG. 10 is stored as a program in a storage device included in the communication apparatus 200 and is implemented when the program is executed by the controller included in the signal processing circuit 60.

The controller of the signal processing circuit 60 controls each of the switches SW1 and SW2 to be electrically disconnected (step S10). The state of the high frequency module 100 is controlled to be in the reception mode. The controller of the signal processing circuit 60 determines whether or not a transmission instruction has been received (step S20). The transmission instruction is transmitted from, for example, a CPU, included in the communication apparatus 200 to the controller of the signal processing circuit 60. In the case where a transmission instruction has not been received (NO in step S20), the controller of the signal processing circuit 60 causes the process to return to step S10.

In the case where a transmission instruction has been received (YES in step S20), the controller of the signal processing circuit 60 controls each of the switches SW1 and SW2 to be electrically connected (step S30). The state of the high frequency module 100 is controlled to be in the transmission mode. After that, the controller of the signal processing circuit 60 determines whether or not transmission processing has finished (step S40). In the case where the transmission processing has not finished (NO in step S40), the controller of the signal processing circuit 60 maintains each of the switches SW1 and SW2 to be electrically connected (step S30).

In the case where the transmission processing has finished (YES in step S40), the controller of the signal processing circuit 60 controls each of the switches SW1 and SW2 to be electrically disconnected. That is, the state of the high frequency module 100 is controlled to be in the reception mode. Thus, in the communication apparatus 200 according to the first embodiment, the state of the high frequency module 100 can be controlled to be in the transmission mode in the case where data transmission is performed and controlled to be in the reception mode in the case where data transmission is not performed. In the example described above, switching between the transmission mode and the reception mode is performed depending on whether or not a transmission instruction has been received. However, switching between the transmission mode and the reception mode may be performed when a predetermined period of time has passed.

The capacitor C1 may correspond to a “first capacitor” in the present disclosure. The connection terminals T1, T2, and T3 may correspond to an “input terminal,” “output terminal,” and “antenna terminal,” respectively, in the present disclosure. The transmission lines Ln1, Ln2, and Ln3 may correspond to a “first transmission line,” a “second transmission line,” and a “third transmission line,” respectively, in the present disclosure. The TLT circuit 70 may correspond to a “first transmission line transformer” in the present disclosure. The end portions E1, E2, E3, E4, E5, and E6 may correspond to a “first end portion,” a “second end portion,” a “third end portion,” a “fourth end portion,” a “fifth end portion,” and a “sixth end portion,” respectively, in the present disclosure. The switches SW1 and SW2 may correspond to a “first switch” and a “second switch,” respectively, in the present disclosure.

### Second Embodiment

In the first embodiment, the configuration in which the transmission lines Ln1 to Ln3 are each wound approximately one turn and function as an impedance matching circuit with an impedance conversion ratio of 9 has been described. In a second embodiment, an example in which the number of turns of the transmission line Ln3 is changed so that an impedance conversion circuit with an impedance conversion ratio that is different from that in the first embodiment is configured, will be described. In the second embodiment, description of configurations that overlap with those in the first embodiment will not be provided again.

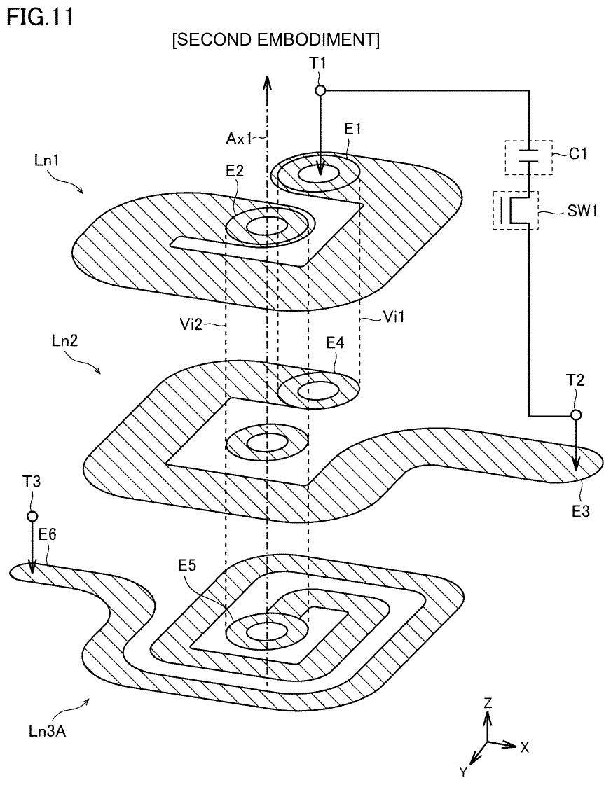

FIG. 11 is a schematic diagram of transmission lines Ln1, Ln2, and Ln3A in the second embodiment. Shapes of the transmission lines Ln1 and Ln2 illustrated in FIG. 11 have the same shapes as those of the transmission lines Ln1 and Ln2 illustrated in FIG. 3. In contrast, in the transmission line Ln3A in the second embodiment, a transmission path from the end portion E6 to the end portion E5 is wound two turns in a counterclockwise manner. That is, the number of turns of the transmission line Ln3A is two.

Also in the second embodiment, a reception signal goes winding in the counterclockwise direction when seen from the Z-axis positive direction when passing through each of the transmission lines Ln1, Ln2, and Ln3A. Thus, the transmission lines Ln1, Ln2, and Ln3A function as an inductor indicated by the arrows A12, A13, and A14 explained above with reference to FIG. 3. That is, also in the second embodiment, the inductor including the transmission lines Ln1, Ln2, and Ln3A functions as a matching circuit that achieves impedance matching between the low noise amplifier 20 and the connection terminal T3.

Furthermore, since the transmission line Ln2 in the second embodiment and the transmission line Ln2 in the first embodiment have the same inductance, the capacitor C1 and the inductor L256, which includes the transmission line Ln2, form the LC parallel resonance circuit 90. Thus, the characteristics of the isolation between the low noise amplifier 20 and the power amplifier 10 can be improved.

Also in the high frequency module 100 illustrated in FIG. 11, a transmission signal is transmitted through the same transmission lines as those described above with reference to FIG. 7 to the antenna 30. The transmission signal flowing through the transmission line Ln3A causes an odd mode current to be excited in the transmission line Ln2. The number of turns of the transmission line Ln3A is twice the number of turns of the transmission line Ln2. Therefore, the size of the odd mode current excited in the transmission line Ln2 is twice the size of the transmission signal flowing through the transmission line Ln3A.

As in the first embodiment, since a reverse current of the transmission signal flowing through the transmission line Ln1 flows in the transmission line Ln2, the currents flowing in the transmission lines Ln1 and Ln2 are in the odd mode and a reverse voltage is excited in the transmission line Ln2. Thus, the odd mode current of the size that is triple the size of the transmission signal flowing in a series circuit including the transmission line Ln1 and the transmission line Ln3 is excited in the transmission line Ln2.

With the configuration in the second embodiment, a current of a value that is one fourth the value of a current i is transmitted to the series circuit including the transmission line Ln1 and the transmission line Ln3A and a current of a value that is three fourths the value of the current i is transmitted to the transmission line Ln2, where the size of the transmission signal that has been amplified by the power amplifier 10 is represented by i. The value of the current of the transmission signal flowing in the capacitor C7 is one fourth the value of the current i.

Regarding voltage, the equation Vin−Vmi=0−Vin is satisfied between the transmission line Ln1 and the transmission line Ln2, as in the first embodiment. In contrast, an equation 2 (0−Vin)=Vmi−Vout is satisfied between the transmission line Ln3A and the transmission line Ln2. That is, an equation Vout=4×Vin is obtained. Thus, the voltage Vout at the capacitor C7 is four times the voltage Vin of the transmission signal that has been amplified by the power amplifier 10.

When a load is connected to the capacitor C7, the impedance when the load side is seen from the power amplifier 10 is one sixteenth the impedance of the load connected to the capacitor C7. When a load is connected to the power amplifier 10, the impedance when the load side is seen from the capacitor C7 is sixteen times the load connected to the power amplifier 10. A TLT circuit 70A in the second embodiment functions as an impedance conversion circuit with an impedance conversion ratio of 16. As described above, the impedance conversion ratio of the TLT circuit 70 can be adjusted by changing the number of turns of the transmission line Ln3. Furthermore, in the second embodiment, the capacitor C1 and the inductor L256 form the LC parallel resonance circuit 90, which prevents transmission of the transmission signal to the low noise amplifier 20. That is, also in the second embodiment, the characteristics of the isolation between the low noise amplifier 20 and the power amplifier 10 can be improved in the transmission mode.

### (First Modification)

In the first and second embodiments, the example in which the power supply voltage VCC is supplied through the power supply line Ln7 for power supply to the output terminal of the power amplifier 10 has been described. In a first modification, an example in which the power supply voltage VCC is supplied through the transmission line Ln2 of the TLT circuit 70 to the power amplifier 10 will be described. In the first modification, description of configurations that overlap with those in the first embodiment will not be provided again.

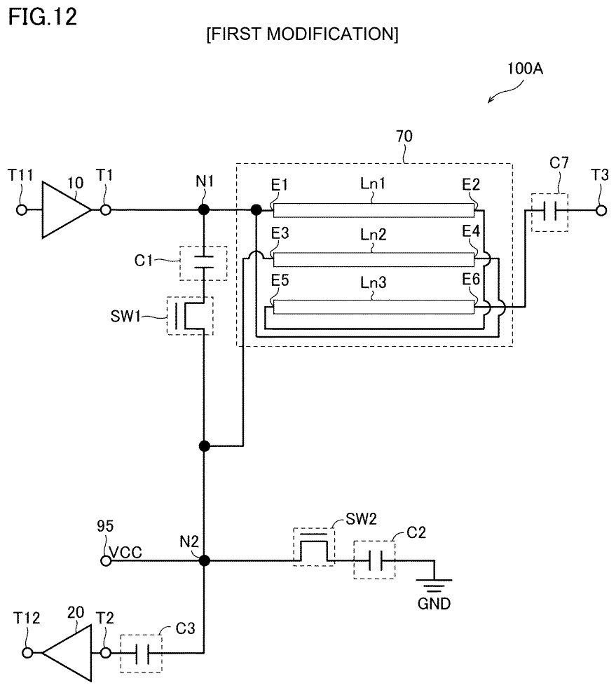

FIG. 12 is a diagram illustrating a detailed configuration of a high frequency module 100A according to the first modification. As illustrated in FIG. 12, the power supply terminal 95 is connected to the end portion E3 of the transmission line Ln2. The high frequency module 100A according to the first modification includes a capacitor C3 between the low noise amplifier 20 and the switch SW2. The capacitor C3 functions as a DC-cutting capacitor.

In the high frequency module 100A according to the first modification, since the power supply voltage VCC supplied from the power supply terminal 95 is supplied through the transmission line Ln2 to the power amplifier 10, the capacitor C6 in the first embodiment is removed. Furthermore, in the high frequency module 100A according to the first modification, a shunt line including the capacitor C8 in the first embodiment is removed. That is, the high frequency module 100A according to the first modification includes neither the capacitor C6, which is connected to the output terminal of the power amplifier 10, nor the capacitor C8.

In the transmission mode, the switches SW1 and SW2 are each electrically connected. The power supply voltage VCC supplied from the power supply terminal 95 can pass through neither the capacitor C1 nor the capacitor C3. In the first modification, instead of the capacitor C8 in the first embodiment, the capacitor C2 functions as a bypass capacitor for bypassing noise. Thus, in the first modification, the power supply voltage VCC supplied from the power supply terminal 95 is supplied through the transmission line Ln2 to the power amplifier 10.

As described above, in the first modification, there is no need to provide a shunt line including the capacitor C8. In other words, in the first modification, a shunt line including the capacitor C2, which is used for the TLT circuit 70, can also be used as a power supply line used for the power supply terminal 95.

Furthermore, also in the first modification, the capacitor C1 and the inductor L256 form the LC parallel resonance circuit 90, which prevents transmission of a transmission signal to the low noise amplifier 20. That is, also in the first modification, the characteristics of the isolation between the low noise amplifier 20 and the power amplifier 10 can be improved in the transmission mode while the size of the high frequency module 100A is reduced.

The capacitor C2 may correspond to a “second capacitor” in the present disclosure. The capacitor C3 may correspond to a “third capacitor” in the present disclosure.

### (Second Modification)

In the first and second embodiments, the example in which the power amplifier 10 is provided as means for amplifying a transmission signal has been described. In a second modification, an example in which a Doherty amplifier is provided instead of the power amplifier 10 will be described. In the second modification, description of configurations that overlap with those in the first embodiment will not be provided again.

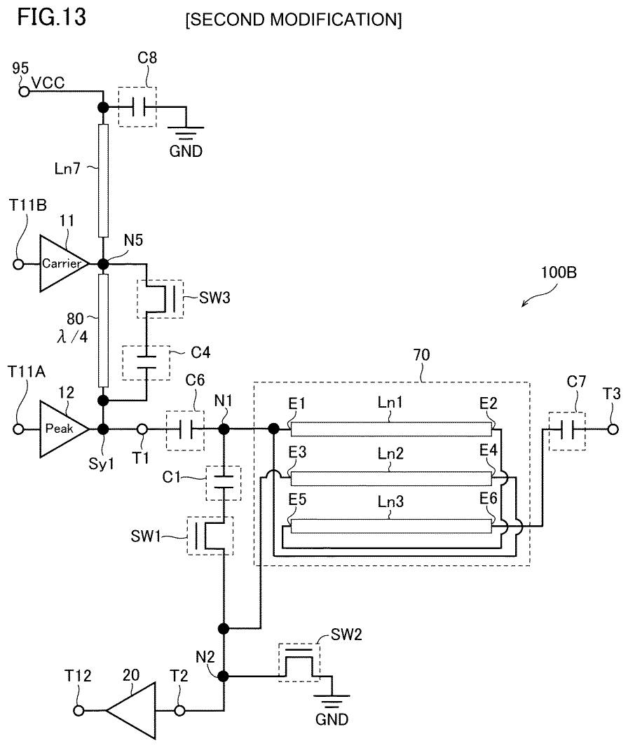

FIG. 13 is a diagram illustrating a detailed configuration of a high frequency module 100B according to the second modification. The high frequency module 100B according to the second modification includes a phase shifter 80, a carrier amplifier 11, a peak amplifier 12, a switch SW3, and a capacitor C4, instead of the power amplifier 10 in the first embodiment. Furthermore, the high frequency module 100B according to the second modification includes connection terminals T11A and T11B, instead of the connection terminal T11 in the first embodiment.

In the high frequency module 100B according to the second modification, the peak amplifier 12 is connected between the connection terminal T11A and the capacitor C6. Furthermore, the carrier amplifier 11 is connected between the connection terminal T11B and the capacitor C6. The high frequency module 100B according to the second modification includes a so-called “Doherty amplifier.”

A class-A amplifier or a class-AB amplifier with relatively less distortion is used as the carrier amplifier 11. The carrier amplifier 11 amplifies, using the power supply voltage VCC supplied from the power supply terminal 95, an input signal supplied from the connection terminal T11B.

The phase shifter 80 adjusts the phase of a signal that has been amplified by the carrier amplifier 11. The phase shifter 80 is, for example, a ¼-wavelength transmission line and is capable of delaying by 90 degrees the phase of a signal that has been amplified by the carrier amplifier 11. Furthermore, the phase shifter 80 is capable of rotating the load impedance by 180 degrees on a Smith chart. That is, the phase shifter 80 functions as an impedance inverter.

For example, a class-C amplifier is used as the peak amplifier 12. With the use of the class-C amplifier, when the voltage level of an input signal reaches a predetermined value or below, the peak amplifier 12 stops its amplifying operation. The peak amplifier 12 amplifies, using the power supply voltage VCC supplied from the power supply terminal 95, the input signal supplied from the connection terminal T11A. The carrier amplifier 11 may include a plurality of amplifiers. Similarly, the peak amplifier 12 may include a plurality of amplifiers.

An output of the carrier amplifier 11 is connected to a synthesizer Sy1 with the phase shifter 80 interposed therebetween. Furthermore, an output of the peak amplifier 12 is connected to the synthesizer Sy1. The synthesizer Sy1 synthesizes signals that have been amplified by the carrier amplifier 11 and the peak amplifier 12.

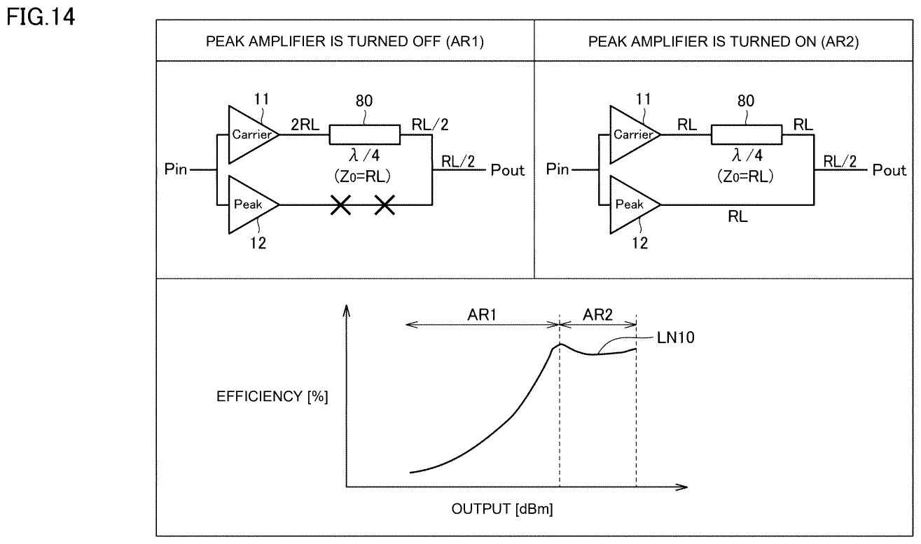

Next, the overview of a Doherty amplifier will be explained. FIG. 14 is a diagram for explaining an operation of a Doherty amplifier.

Schematically, a Doherty amplifier has a configuration in which, as in the second modification, a carrier amplifier and a peak amplifier are connected in parallel between the output terminal and the input terminal and a phase shifter functioning as an impedance inverter is disposed between the carrier amplifier and a synthesizer. The carrier amplifier operates when the output power is small, and both the carrier amplifier and the peak amplifier operate when the output power is larger than a predetermined value. The phase shifter, which functions as the impedance inverter, may be disposed between the peak amplifier and the synthesizer.

In FIG. 14, circuit states and load impedances when the peak amplifier is operating (right diagram) and when the peak amplifier is not operating (left diagram) are illustrated in an upper part, and the relationship between output power and efficiency is illustrated in a lower part.

When both the carrier amplifier and the peak amplifier are operating (the right diagram in the upper part), the load impedance when seen from each of the carrier amplifier and the peak amplifier is represented by RL and the load impedance at a synthesized point is represented by RL/2. In contrast, when the peak amplifier is turned off (the left diagram in the upper part), the load impedance when seen from the carrier amplifier is represented by 2RL due to the phase shifter functioning as an impedance inverter.

Typical amplifiers have a tendency in which efficiency increases as load impedance increases. Therefore, as indicated in the graph in the lower part, with the use of a Doherty amplifier, the efficiency can be increased by an increase in the load impedance in a region AR1 in which the peak amplifier is turned off and the efficiency can be increased by a parallel operation of the carrier amplifier and the peak amplifier in a region AR2 in which the peak amplifier is turned on.

Referring back to FIG. 13, when the state of the high frequency module 100B according to the second modification is the reception mode, the signal processing circuit 60 in the second modification controls the carrier amplifier 11 and the peak amplifier 12 to be turned off and controls the switch SW3 to be electrically connected. In the transmission mode, the signal processing circuit 60 controls the carrier amplifier 11 to be turned on, controls the peak amplifier 12 to be turned on in accordance with the output power, and controls the switch SW3 to be electrically disconnected.

In the reception mode, since the signal processing circuit 60 controls the carrier amplifier 11 and the peak amplifier 12 to be turned off, the impedance when the output terminal of the carrier amplifier 11 is seen from the connection terminal T3 is in an open state. At this time, the phase shifter 80 causes the phase of a reception signal received by the antenna 30 to be delayed by 90 degrees. Thus, regarding the reception signal, the impedance in the phase shifter 80 when the output terminal of the carrier amplifier 11 is seen from the connection terminal T3 is short-circuited.

In the second modification, in the reception mode, the switch SW3 is controlled to be electrically connected. Since the phase shifter 80 functioning as an inductor and the capacitor C4 form an LC parallel resonance circuit, the impedance when the output terminal of the carrier amplifier 11 is seen from the connection terminal T3 is in an open state. That is, the reception signal is not transmitted to the output terminal of the carrier amplifier 11. As described above, in the high frequency module 100B according to the second modification, since the LC parallel resonance circuit including the phase shifter 80 and the capacitor C4 is provided between the carrier amplifier 11 and the peak amplifier 12, transmission of a reception signal to the output terminal of the carrier amplifier 11 is prevented.

Furthermore, also in the second modification, the capacitor C1 and the transmission line Ln2 form the LC parallel resonance circuit 90, which prevents transmission of a transmission signal to the low noise amplifier 20. That is, also in the second modification, the characteristics of the isolation between the low noise amplifier 20 and the power amplifier 10 can be improved in the transmission mode while the size of the high frequency module 100B is reduced.

In the second modification, the connection terminals T11A and T11B may each correspond to an “input terminal” in the present disclosure. The connection terminal T12 may correspond to an “output terminal” in the present disclosure. The capacitor C4 may correspond to a “fourth capacitor” in the present disclosure. The switch SW3 may correspond to a “third switch” in the present disclosure.

### (Third Modification)

In the second modification, the configuration in which a Doherty amplifier in which the phase shifter 80 and the capacitor C4 are connected in parallel between the carrier amplifier 11 and the peak amplifier 12 is applied has been described. In a third modification, an example in which Doherty is applied without the capacitor C4 being provided will be described. In the third modification, description of configurations that overlap with those in the second modification will not be provided again.

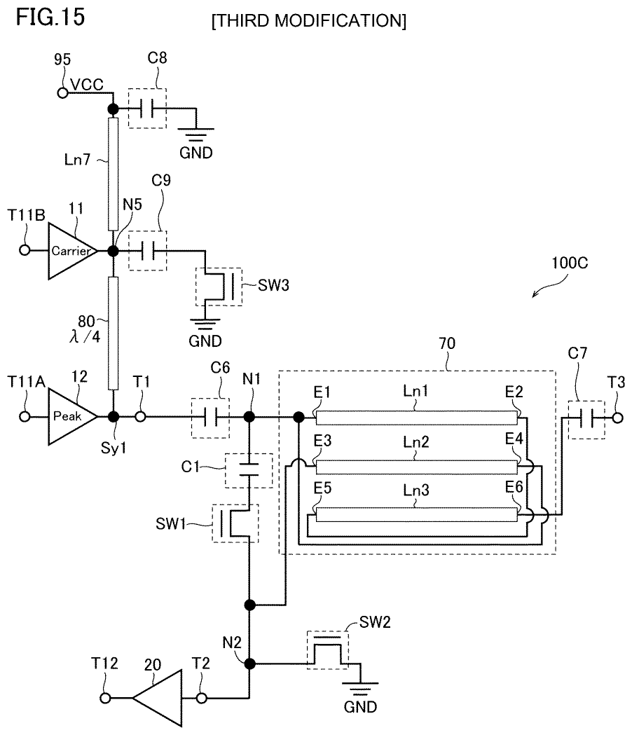

FIG. 15 is a diagram illustrating a detailed configuration of a high frequency module 100C according to the third modification. The high frequency module 100C according to the third modification includes the phase shifter 80, the carrier amplifier 11, the peak amplifier 12, and the switch SW3, as in the second modification. The carrier amplifier 11 is connected to one end of the switch SW3 with a DC-cutting capacitor C9 interposed therebetween, and a ground terminal GND is connected to the other end of the switch SW3.

When the state of the high frequency module 100C according to the third modification is the reception mode, the signal processing circuit 60 in the third modification controls the carrier amplifier 11 and the peak amplifier 12 to be turned off and controls the switch SW3 to be electrically connected. In the transmission mode, the signal processing circuit 60 controls the carrier amplifier 11 and the peak amplifier 12 to be turned on and controls the switch SW3 to be electrically disconnected.

As in the second modification, in the reception mode, the signal processing circuit 60 controls the carrier amplifier 11 and the peak amplifier 12 to be turned off also in the third modification. The impedance when the output terminal of the carrier amplifier 11 is seen from the connection terminal T3 is short-circuited. Thus, in the third modification, the switch SW3 is controlled to be electrically connected in the reception mode.

Also in the third modification, the capacitor C1 and the inductor L256 form the LC parallel resonance circuit 90, which prevents transmission of a transmission signal to the low noise amplifier 20. That is, also in the third modification, the characteristics of the isolation between the low noise amplifier 20 and the power amplifier 10 can be improved in the transmission mode while the size of the high frequency module 100C is reduced.

### (Fourth Modification)

In the second modification, the configuration in which the Doherty amplifier in which the phase shifter 80 and the capacitor C4 are connected in parallel between the carrier amplifier 11 and the peak amplifier 12 is applied has been described. In a fourth modification, a configuration in which the second modification is applied to the first modification is provided. In the fourth modification, description of configurations that overlap with those in the first or second modification will not be provided again.

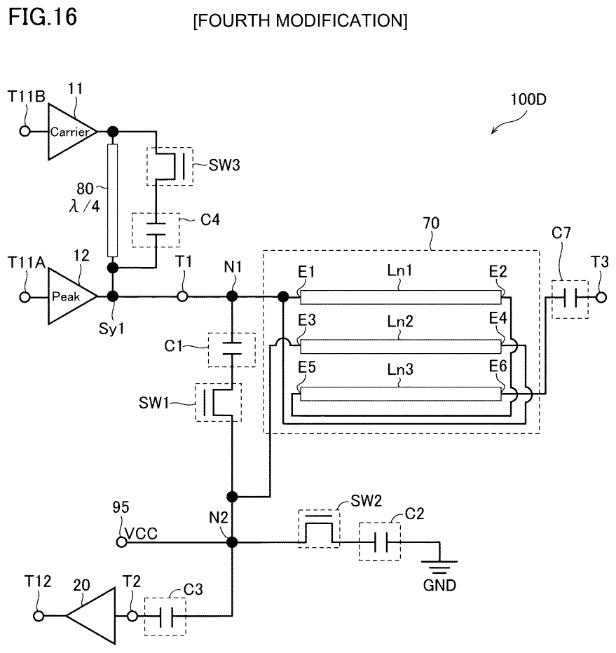

FIG. 16 is a diagram illustrating a detailed configuration of a high frequency module 100D according to the fourth modification. As illustrated in FIG. 16, the high frequency module 100D includes a Doherty amplifier including the carrier amplifier 11 and the peak amplifier 12. Furthermore, in the high frequency module 100D, the phase shifter 80 and the capacitor C4 are connected in parallel between the carrier amplifier 11 and the peak amplifier 12. Moreover, in the high frequency module 100D, the power supply terminal 95 supplies the power supply voltage VCC through the transmission line Ln2 to the peak amplifier 12. Furthermore, the power supply terminal 95 supplies the power supply voltage VCC through the transmission line Ln2 and the phase shifter 80 to the carrier amplifier 11.

Also in the fourth modification, the capacitor C1 and the transmission line Ln2 form the LC parallel resonance circuit 90, which prevents transmission of a transmission signal to the low noise amplifier 20. That is, also in the fourth modification, the characteristics of the isolation between the low noise amplifier 20 and the power amplifier 10 can be improved in the transmission mode while the size of the high frequency module 100D is reduced.

### (Fifth Modification)

In the third modification, the configuration in which the Doherty amplifier in which a shunt line is formed between the carrier amplifier 11 and the peak amplifier 12 is applied has been described. In a fifth modification, a configuration in which the third modification is applied to the first modification is provided. In the fifth modification, description of configurations that overlap with those in the first or third modification will not be provided again.

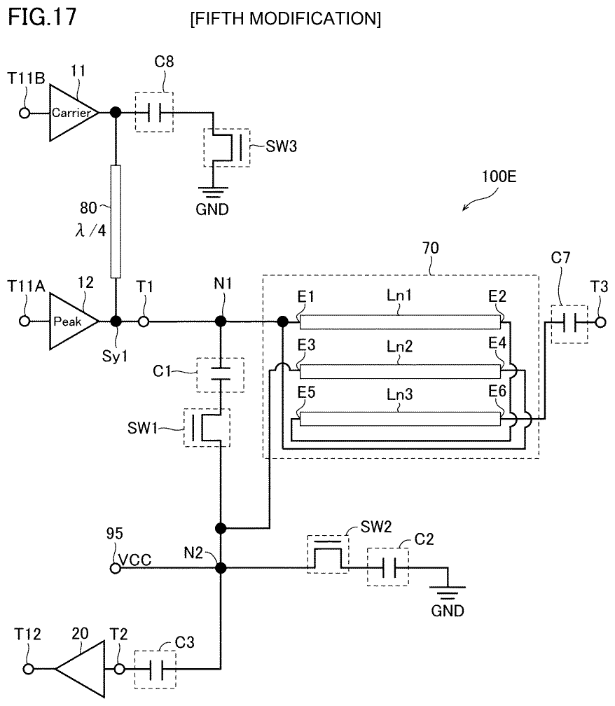

FIG. 17 is a diagram illustrating a detailed configuration of a high frequency module 100E according to the fifth modification. As illustrated in FIG. 17, the high frequency module 100E includes a Doherty amplifier including the carrier amplifier 11 and the peak amplifier 12. Furthermore, in the high frequency module 100E, when the switch SW3 is electrically connected, a shunt line is formed between the carrier amplifier 11 and the peak amplifier 12. In the fifth modification, the capacitor C8, which is for DC-cutting, is connected between the switch SW3 and the carrier amplifier 11.

Furthermore, in the high frequency module 100E, the power supply terminal 95 supplies the power supply voltage VCC through the transmission line Ln2 to the peak amplifier 12. The power supply terminal 95 also supplies the power supply voltage VCC through the transmission line Ln2 and the phase shifter 80 to the carrier amplifier 11.

Also in the fifth modification, the capacitor C1 and the inductor L256 form the LC parallel resonance circuit 90, which prevents transmission of a transmission signal to the low noise amplifier 20. That is, also in the fifth modification, the characteristics of the isolation between the low noise amplifier 20 and the power amplifier 10 can be improved in the transmission mode while the size of the high frequency module 100E is reduced.

### (Sixth Modification)

In the first embodiment, the configuration including the connection terminals T11 and T13 as input terminals of the high frequency module 100 in the transmission mode has been described. In a sixth modification, a configuration that synthesizes transmission signals is provided to improve transmission efficiency. In the sixth modification, description of configurations that overlap with those in the first embodiment will not be provided again.

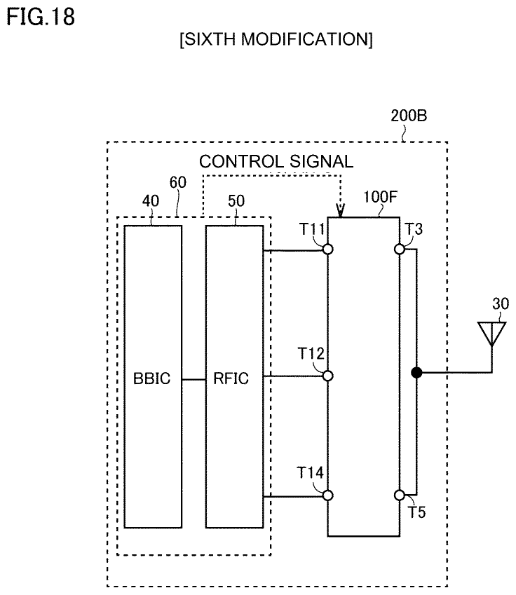

FIG. 18 is a schematic configuration diagram of a communication apparatus 200B according to the sixth modification. The communication apparatus 200B according to the sixth modification includes a high frequency module 100F. The high frequency module 100F includes connection terminals T14 and T5, in addition to the connection terminals T11 and T12 as input terminals of the high frequency module 100 in the transmission mode. The RFIC 50 is capable of outputting a signal generated by up-conversion through the connection terminal T11 or the connection terminal T14 to the high frequency module 100F. The antenna 30 transmits, as a radio wave, high frequency signals (transmission signals) received from the connection terminals T3 and T5 of the high frequency module 100F.

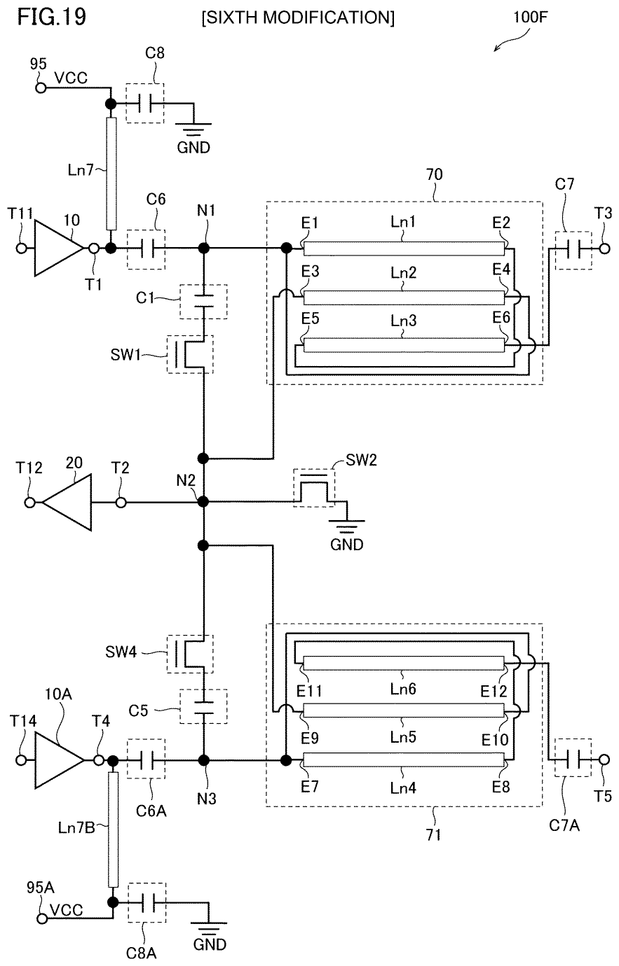

FIG. 19 is a diagram illustrating a detailed configuration of the high frequency module 100F according to the sixth modification. Referring to FIG. 19, the high frequency module 100F includes a power amplifier 10A, a TLT circuit 71, a switch SW4, capacitors C5, C6A, C7A, and C8A, a power supply terminal 95A, and a power supply line Ln7B, in addition to the configurations included in the high frequency module 100 according to the first embodiment.

In the sixth modification, the power amplifier 10A has a function corresponding to the power amplifier 10. The switch SW4 has a function corresponding to the switch SW1. The capacitors C5, C6A, C7A, and C8A have functions corresponding to the capacitors C1, C6, C7, and C8, respectively. The power supply terminal 95A has a function corresponding to the power supply terminal 95. The power supply line Ln7B has a function corresponding to the power supply line Ln7.

In the sixth modification, the TLT circuit 71 includes transmission lines Ln4, Ln5, and Ln6. The transmission line Ln4 includes end portions E7 and E8. The transmission line Ln5 includes end portions E9 and E10. The transmission line Ln6 includes end portions E11 and E12. The TLT circuit 71 shares a shunt line including the switch SW2 with the TLT circuit 70.

As described above, in the sixth modification, transmission signals can be transmitted through two signal paths to the antenna 30. Thus, in the sixth modification, transmission signals can be synthesized together and transmitted as a radio wave from the antenna 30.

Also in the sixth modification, the capacitor C1 and the inductor L256 form the LC parallel resonance circuit 90, which prevents transmission of a transmission signal to the low noise amplifier 20. That is, also in the sixth modification, the characteristics of the isolation between the low noise amplifier 20 and the power amplifier 10 can be improved in the transmission mode while the size of the high frequency module 100F is reduced.

A connection terminal T4 may correspond to a “fourth connection terminal” in the present disclosure. The connection terminal T5 may correspond to a “fifth connection terminal” in the present disclosure. The capacitor C5 may correspond to a “fifth capacitor” in the present disclosure. The transmission lines Ln4, Ln5, and Ln6 may correspond to a “fourth transmission line,” a “fifth transmission line,” and a “sixth transmission line,” respectively, in the present disclosure. The TLT circuit 71 may correspond to a “second transmission line transformer” in the present disclosure. The end portions E7, E8, E9, E10, E11, and E12 may correspond to a “seventh end portion,” an “eighth end portion,” a “ninth end portion,” a “tenth end portion,” an “eleventh end portion,” and a “twelfth end portion,” respectively, in the present disclosure. The switch SW4 may correspond to a “fourth switch” in the present disclosure.

Herein, “connection” includes both direct connection and indirect connection. More specifically, direct connection represents connection between the capacitor C1 and the switch SW1 in FIG. 19. Furthermore, indirect connection represents connection between the switch SW1 and the capacitor C6 in FIG. 19. The switch SW1 is connected in an indirect manner to the capacitor C6 with the capacitor C1 interposed therebetween.

### <Appendix 1>

A high frequency module comprising: an input terminal, an output terminal, and an antenna terminal; a first transmission line transformer that includes a first transmission line, a second transmission line, and a third transmission line; a first capacitor and a first switch that are connected in series between the input terminal and the output terminal; and a second switch that is connected between the output terminal and a ground terminal, wherein the first transmission line includes a first end portion that is connected to the input terminal and a second end portion, wherein the second transmission line includes a third end portion that is connected to the output terminal and a fourth end portion that is connected to the input terminal, wherein the third transmission line includes a fifth end portion that is connected to the second end portion and a sixth end portion that is connected to the antenna terminal, and wherein the first capacitor and the first switch are connected in series between the first end portion and the third end portion.

### <Appendix 2>

The high frequency module according to appendix 1, wherein when the first switch is electrically connected, the first capacitor and the second transmission line form a parallel resonator.

### <Appendix 3>

The high frequency module according to appendix 1 or 2, wherein when the first switch is not electrically connected, the first transmission line, the second transmission line, and the third transmission line form a coil in an integrated manner.

### <Appendix 4>

The high frequency module according to appendix 3, wherein the first transmission line, the second transmission line, and the third transmission line are each wound around the same axis.

### <Appendix 5>

The high frequency module according to appendix 4, wherein the number of turns of the third transmission line is the same as the number of turns of the second transmission line.

### <Appendix 6>

The high frequency module according to appendix 4, wherein the number of turns of the third transmission line is larger than the number of turns of the second transmission line.

### <Appendix 7>

The high frequency module according to any one of appendices 1 to 6, further comprising: an amplifier that is connected between the input terminal and the first transmission line; and a power supply terminal to which power to be supplied to the amplifier is inputted.

### <Appendix 8>

The high frequency module according to any one of appendices 1 to 6, further comprising: an amplifier that is connected between the input terminal and the first transmission line; a power supply terminal that is connected to the output terminal, power to be supplied to the amplifier being input to the power supply terminal; a second capacitor that is connected between the second switch and the ground terminal; and a third capacitor that is connected between the second transmission line and the output terminal.

### <Appendix 9>

The high frequency module according to any one of appendices 1 to 8, further comprising: a carrier amplifier that is connected between the input terminal and the first transmission line; a peak amplifier that is connected to the input terminal; a phase shifter that is connected between an output terminal of the carrier amplifier and an output terminal of the peak amplifier; and a third switch and a fourth capacitor that are connected in series between the output terminal of the carrier amplifier and the output terminal of the peak amplifier.

### <Appendix 10>

The high frequency module according to any one of appendices 1 to 8, further comprising: a carrier amplifier that is connected between the input terminal and the first transmission line; a peak amplifier that is connected to the input terminal; a phase shifter that is connected between an output terminal of the carrier amplifier and an output terminal of the peak amplifier; and a third switch that is connected between the output terminal of the carrier amplifier and a ground terminal.

### <Appendix 11>

The high frequency module according to appendix 9 or 10, wherein the phase shifter is a ¼-wavelength transmission line.

### <Appendix 12>

The high frequency module according to any one of appendices 1 to 11, further comprising: a fourth connection terminal and a fifth connection terminal; a second transmission line transformer that includes a fourth transmission line, a fifth transmission line, and a sixth transmission line; and a fifth capacitor and a fourth switch that are connected in series between the fourth connection terminal and the output terminal, wherein the fourth transmission line includes a seventh end portion that is connected to the fourth connection terminal and an eighth end portion, wherein the fifth transmission line includes a ninth end portion that is connected to the output terminal and a tenth end portion that is connected to the fourth connection terminal, wherein the sixth transmission line includes an eleventh end portion that is connected to the eighth end portion and a twelfth end portion that is connected to the fifth connection terminal, wherein the fifth capacitor is connected to the seventh end portion, and wherein the fourth switch is connected to the ninth end portion.

### <Appendix 13>

A communication apparatus including the high frequency module according to any one of appendices 1 to 12, the communication apparatus comprising: a signal processing circuit that processes a high frequency signal passing through the high frequency module.

### <Appendix 14>

A control method for use in a high frequency module including an input terminal, an output terminal, and an antenna terminal, a first transmission line transformer that includes a first transmission line, a second transmission line, and a third transmission line, a first capacitor and a first switch that are connected in series between the input terminal and the output terminal, and a second switch that is connected between the output terminal and a ground terminal, wherein the first transmission line includes a first end portion that is connected to the input terminal and a second end portion, wherein the second transmission line includes a third end portion that is connected to the output terminal and a fourth end portion that is connected to the input terminal, wherein the third transmission line includes a fifth end portion that is connected to the second end portion and a sixth end portion that is connected to the antenna terminal, and wherein the first capacitor and the first switch are connected in series between the first end portion and the third end portion, the control method comprising: a step of causing each of the first switch and the second switch to be electrically disconnected when receiving a radio wave; and a step of causing each of the first switch and the second switch to be electrically connected when transmitting a radio wave.

The embodiments disclosed herein are to be considered in all respects to be illustrative and not restrictive. The scope of the present disclosure is defined by the claims, rather than the description provided above, and is intended to include all modifications within the meaning and scope equivalent to the scope of the claims.

10, 10A power amplifier, 11 carrier amplifier, 12 peak amplifier, 20 low noise amplifier, 30 antenna, 60 signal processing circuit, 70, 70A, 70Z, 71 TLT circuit, 80 phase shifter, 90 parallel resonance circuit, 95, 95A power supply terminal, 100, 100A to 100F, 100Z high frequency module, 200, 200B communication apparatus, A11 to A15, A21 to A28, A31, A32, A256 arrow, AR1, AR2 region, Ax1 axis, C1 to C9 capacitor, D1 attenuation pole, E1 to E12 end portion, GND ground terminal, LIZ, L256 inductor, LE1 line, Ln1 to Ln3, Ln3A, Ln4 to Ln6 transmission line, Ln7, Ln7B power supply line, N1, N2 connection node, SW1 to SW4, SW1Z, SW2Z switch, Sy1 synthesizer, T1 to T5, T11, T12, T14 connection terminal, Vi1, Vi2 via.

1. A high frequency module comprising:
an input terminal, an output terminal, and an antenna terminal;
a first transmission line transformer that comprises a first transmission line, a second transmission line, and a third transmission line;
a first capacitor and a first switch that are connected in series between the input terminal and the output terminal; and
a second switch that is connected between the output terminal and a ground terminal,
wherein the first transmission line has a first end that is connected to the input terminal, and a second end,
wherein the second transmission line has a third end that is connected to the output terminal, and a fourth end that is connected to the input terminal,
wherein the third transmission line has a fifth end that is connected to the second end, and a sixth end that is connected to the antenna terminal, and
wherein the first capacitor and the first switch are connected in series between the first end and the third end.

2. The high frequency module according to claim 1, wherein when the first switch is electrically connected, the first capacitor and the second transmission line form a parallel resonator.

3. The high frequency module according to claim 1, wherein when the first switch is not electrically connected, the first transmission line, the second transmission line, and the third transmission line form a coil in an integrated manner.

4. The high frequency module according to claim 3, wherein the first transmission line, the second transmission line, and the third transmission line are each wound around the same axis.

5. The high frequency module according to claim 4, wherein a number of turns of the third transmission line is the same as a number of turns of the second transmission line.

6. The high frequency module according to claim 4, wherein the number of turns of the third transmission line is greater than the number of turns of the second transmission line.

7. The high frequency module according to claim 1, further comprising:
an amplifier that is connected between the input terminal and the first transmission line; and
a power supply terminal to which power for the amplifier is input.

8. The high frequency module according to claim 1, further comprising:
an amplifier that is connected between the input terminal and the first transmission line;
a power supply terminal that is connected to the output terminal, power for the amplifier being input to the power supply terminal;
a second capacitor that is connected between the second switch and the ground terminal; and
a third capacitor that is connected between the second transmission line and the output terminal.

9. The high frequency module according to claim 1, further comprising:
a carrier amplifier that is connected between the input terminal and the first transmission line;
a peak amplifier that is connected to the input terminal;
a phase shifter that is connected between an output terminal of the carrier amplifier and an output terminal of the peak amplifier; and
a third switch and a fourth capacitor that are connected in series between the output terminal of the carrier amplifier and the output terminal of the peak amplifier.

10. The high frequency module according to claim 1, further comprising:
a carrier amplifier that is connected between the input terminal and the first transmission line;
a peak amplifier that is connected to the input terminal;
a phase shifter that is connected between an output terminal of the carrier amplifier and an output terminal of the peak amplifier; and
a third switch that is connected between the output terminal of the carrier amplifier and a ground terminal.

11. The high frequency module according to claim 9, wherein the phase shifter is a ¼-wavelength transmission line.

12. The high frequency module according to claim 1, further comprising:
a fourth connection terminal and a fifth connection terminal;
a second transmission line transformer that comprises a fourth transmission line, a fifth transmission line, and a sixth transmission line; and
a fifth capacitor and a fourth switch that are connected in series between the fourth connection terminal and the output terminal,
wherein the fourth transmission line has a seventh end that is connected to the fourth connection terminal, and an eighth end,
wherein the fifth transmission line has a ninth end that is connected to the output terminal, and a tenth end that is connected to the fourth connection terminal,
wherein the sixth transmission line has an eleventh end that is connected to the eighth end, and a twelfth end that is connected to the fifth connection terminal,
wherein the fifth capacitor is connected to the seventh end, and
wherein the fourth switch is connected to the ninth end.

13. A communication apparatus including the high frequency module according to claim 1, the communication apparatus comprising:
a signal processing circuit that is configured to process a high frequency signal passing through the high frequency module.

14. A control method for use in a high frequency module comprising:
an input terminal, an output terminal, and an antenna terminal,
a first transmission line transformer that comprises a first transmission line, a second transmission line, and a third transmission line,
a first capacitor and a first switch that are connected in series between the input terminal and the output terminal, and
a second switch that is connected between the output terminal and a ground terminal,
wherein the first transmission line has a first end that is connected to the input terminal, and a second end,
wherein the second transmission line has a third end that is connected to the output terminal, and a fourth end that is connected to the input terminal,
wherein the third transmission line has a fifth end that is connected to the second end, and a sixth end that is connected to the antenna terminal, and
wherein the first capacitor and the first switch are connected in series between the first end and the third end,
the control method comprising:
a step of causing each of the first switch and the second switch to be electrically disconnected when receiving a radio wave; and
a step of causing each of the first switch and the second switch to be electrically connected when transmitting a radio wave.
